(19) United States
(12) Patent Application Publication
(10) Pub. No.: US 2025/0045616 A1
(43) Pub. Date: Feb. 6, 2025

(54) METHOD FOR DETERMINING A CONFIGURATION OF A QUANTUM PROCESSOR TO SOLVE AN OPTIMIZATION PROBLEM

(71) Applicant: PASQAL, MASSY (FR)

(72) Inventors: Lucas LECLERC, PARIS (FR); Slimane THABET, PARIS (FR); Sebastián GRIJALVA, PARIS (FR); Loïc HENRIET, NANTES (FR)

(21) Appl. No.: 18/716,095

(22) PCT Filed: Dec. 2, 2022
(86) PCT No.: PCT/EP2022/084222

§ 371 Date: Jun. 3, 2024

(30) Foreign Application Priority Data
Dec. 3, 2021 (FR) FR2112918

(51) Int. Cl. G06N 10/40; G06N 10/60

(52) U.S. Cl. CPC G06N 10/40; G06N 10/60

(57) ABSTRACT

The present invention relates to a method for determining a configuration of a quantum processor to solve an optimization problem, the quantum processor comprising neutral atoms that are able to be manipulated to form qubits, the quantum processor having an interaction Hamiltonian that is dependent on the positions of the neutral atoms, the method comprising:
a. determining a target Hamiltonian for the quantum processor according to a QUBO matrix, the QUBO matrix describing the optimization problem in the form of a quadratic unconstrained binary optimization, and
b. determining the positions of the neutral atoms of the quantum processor so as to minimize a difference between the interaction Hamiltonian of the quantum processor and the target Hamiltonian, the step of determining the positions comprising the use of a machine learning tool that is able to determine the positions of the atoms according to data from the target Hamiltonian.

### TECHNICAL FIELD OF THE INVENTION

The present invention relates to a method for determining a configuration of a quantum processor for solving an optimization problem. The invention further relates to a computer program product. The invention further relates to an associated readable storage medium.

### CONTEXT OF THE INVENTION

Quantum computing is a fast-growing technology that is interesting, in particular, for solving combinatorial optimization problems. Such problems, which arise in all industrial fields (logistics, energy, telecommunication, IT, banking/finance, etc.), are generally not compatible with the computational capabilities of conventional computers.

Combinatorial optimization problems are suitable for being reformulated in the form of Quadratic Unconstrained Binary Optimization (QUBO) problems. A QUBO problem consists in finding the string of bits x∈ [symbol] , i.e. an N-dimensional vector of 0 and 1, minimizing the cost function C(x)=x^{T}Mx, with M a symmetric real matrix.

Methods for solving QUBO problems by means of quantum processors are known from the prior art. Such methods use e.g. a quantum adiabatic algorithm as described in the paper by Edward Farhi, Jeffrey Goldstone, Sam Gutmann, Joshua Lapan, Andrew Lundgren, and Daniel Preda. A Quantum Adiabatic Evolution Algorithm Applied to Random Instances of an NP-Complete Problem. Science, 292 (5516): 472-476, Avril 2001. doi: 10.1126/science.1057726. Other methods are based on a Quantum Approximate Optimization Algorithm (QAOA) as described in the article by Edward Farhi, Jeffrey Goldstone, and Sam Gutmann. A Quantum Approximate Optimization Algorithm. arXiv e-prints, art. arXiv: 1411.428-11-2014.

The implementation of such solving methods involves building a Hamiltonian for the quantum processor that is closely related to the cost function C. More specifically, to implement such methods, one seeks to build a target Hamiltonian H_{c} for the quantum processor such that [symbol] x|H_{c}|x [symbol] =C(x). A quantum state is typically written as |Ψ [symbol] =Σᵢαᵢ|x [symbol] ᵢ, where |αᵢ|² denotes the probability of performing a measurement on the quantum processor in the base state |x [symbol] ᵢ. For example, for N=5, an instance of |x [symbol] would be |01011 [symbol] with the qubits 1 and 3 in one state and the qubits 2, 4 and 5 in another state. [symbol] x|H_{c}|x [symbol] denotes the measured value of the observable H_{c} when a measurement is performed on the quantum processor in the state |x [symbol] .

Means to generate exactly the target Hamiltonian H_{c} have been developed for quantum processors based on superconducting quantum circuits or processors, such as the machines of the company D-wave.

However, such means cannot be used for other quantum processor technologies, and in particular for quantum processors based on neutral atoms in analogue operation. Indeed, the number of degrees of freedom possible by the arrangement of N atoms in the plane or in the space scales linearly with N, so that it quickly becomes complicated to satisfy the quadratic number of constraints imposed during the generation of a matrix of size 2N.

Thereby, the performance of quantum processors based on neutral atoms is limited for solving QUBO problems. However, by the very use of neutral atoms, such processors have many advantages over processors based on artificial atoms such as superconducting circuits or silicon spin qubits.

Hence there is a need for a way to improve the performance of a quantum processor based on neutral atoms, for solving a QUBO problem.

### SUMMARY OF THE INVENTION

To this end, the subject matter of the present description is a method for determining a configuration of a quantum processor for solving an optimization problem, the quantum processor comprising neutral atoms suitable for being manipulated to form qubits, the quantum processor having an interaction Hamiltonian describing the interactions between qubits, the interaction Hamiltonian being function of the positioning of the neutral atoms, the method comprising the following steps implemented by a calculator:
a. determining a target Hamiltonian for the quantum processor according to a QUBO matrix, the QUBO matrix describing the optimization problem in the form of a quadratic unconstrained binary optimization, and
b. determining the positions of the neutral atoms of the quantum processor so as to minimize a difference between the interaction Hamiltonian of the quantum processor and the target Hamiltonian, the step of determining the positions comprising the use of a machine learning tool that is able to determine the positions of the atoms according to data from the target Hamiltonian, the determined positions defining a processor configuration suitable for being used for solving the optimization problem.

The present invention further relates to a method of solving an optimization problem by a quantum processor, said method of solving comprising the steps of the method of determining a configuration of the quantum processor as described above, and in which the method of solving comprises a step of positioning the neutral atoms of the quantum processor according to the positions determined for solving the optimization problem.

According to a particular embodiment, the method of solving further comprises a step of solving the optimization problem, with the neutral atoms of the quantum processor positioned according to the determined positions, by using a quantum approximate optimization algorithm, called QAOA, or a quantum adiabatic algorithm.

According to other particular embodiments, the determination and/or solving method further comprises one or a plurality of the following features, taken individually or according to all technically possible combinations:
the learning tool is a manifold machine learning tool suitable for performing a non-linear reduction of the dimensionality of the data at the input of the tool;
the multiple machine learning tool is based on a multidimensional positioning algorithm;
the QUBO matrix is formulated in the form of a symmetrical real matrix, the step of determining the positions comprising:
   the determination of a matrix, called the distance matrix, as a function of the QUBO matrix, each coefficient in a position i, j of the distance matrix corresponding to a distance between the qubit i and the qubit j, and
   the determination, by the learning tool, of the positions of the neutral atoms according to the distance matrix;
the step of determining the positions comprises the determination of an intermediate matrix as a function of the QUBO matrix, the intermediate matrix having coefficients equal to zero on the diagonal thereof and the same coefficients as the QUBO matrix otherwise, the distance matrix being obtained as a function of the intermediate matrix;
the coefficients of the distance matrix are obtained according to the following formula:

$${[ {D}_{0} ]}_{i , j} = \frac{{C}_{6}}{{( {[ {U}_{0} ]}_{i , j} )}^{1 / 6}}$$

### Where:

[D₀]_{i,j} is the coefficient in row i and column j of the distance matrix D₀,
[U₀]_{i,j} is the coefficient in row i and column j of the intermediate matrix U₀, and
C₆ Is a coefficient dependent on a Rydberg level chosen as the excited state for the neutral atoms of the quantum processor.
   the target Hamiltonian verifies the following equation:

$$〈 x \vert {H}_{c} \vert x 〉 = {x}^{T} Mx$$

### Where:

H_{c} is the target Hamiltonian for the optimization problem under consideration,
M is the QUBO matrix,
x is a state vector,
x^{T} is the transpose of the vector x,
[symbol] ϕ| is the bra of ϕ in bra-ket notation, and
   |Ψ [symbol] is the ket of Ψ in bra-ket notation.

The present invention further relates to a computer program product on which a computer program is stored comprising program instructions, the computer program being loaded on a data processing unit and leading to the implementation of steps of determination of a target Hamiltonian and of determination of the positions of the method such as defined hereinabove when the computer program is implemented on the data processing unit.

The present description further relates to a readable storage medium on which a computer program is stored comprising program instructions, the computer program being loaded on a data processing unit and leading to the implementation of steps of determination of a target Hamiltonian and of determination of the positions of the method such as defined hereinabove when the computer program is implemented on the data processing unit.

### BRIEF DESCRIPTION OF DRAWINGS

Other features and advantages of the invention will appear upon reading hereinafter the description of the embodiments of the invention, given only as an example, and making reference to the following drawings:

FIG. 1, a flowchart of an example of implementation of a method for determining a configuration of a quantum processor for solving an optimization problem,

FIG. 2, a specific example of implementation of the method shown in FIG. 1,

FIG. 3, an example of a graph comparing positions of neutral atoms determined by the method of the invention with positions on a triangular array for a first family of QUBO matrices, the first family grouping QUBO matrices all having equal coefficients,

FIG. 4, an example of a graph similar to the graph shown in FIG. 3 for a second family of QUBO matrices, the second family grouping together QUBO matrices having coefficients with small differences therebetween,

FIG. 5, an example of a graph similar to the graphs shown in FIGS. 4 and 5 plotted for a third family of QUBO matrices, the third family grouping together QUBO matrices having coefficients with large differences therebetween, and

FIG. 6, an example of a graph illustrating the performance of a quantum processor for solving a QUBO problem from a QAOA algorithm when the neutral atoms of the processor are positioned according to positions determined by the method of the invention, as well as when the positions are on a triangular array.

### DETAILED DESCRIPTION OF EMBODIMENTS

The determination method which will be described hereinafter in the description is carried out for a quantum processor, also called a quantum computer.

A quantum processor is a network of qubits, as well as a hardware for manipulating the qubits. A quantum processor is suitable for performing quantum operations on qubits.

A quantum processor uses quantum properties of matter, such as superimposition and entanglement, to perform operations on the data. Unlike a conventional computer based on transistors working on binary data (coded on bits, 0 or 1), the quantum processor works on qubits the quantum state of which can take a number of values, no longer discrete but continuous.

More particularly, a qubit refers to a two-level quantum mechanical system. For example, a qubit comprises two basic quantum states |0> and |1> representing the possible quantum states of the qubit. According to the superposition principle of quantum mechanics, any superposition of the form a|0>+b|1> (a and b being complex numbers and aa*+bb*=1) is a possible quantum state of the qubit.

The quantum processor considered during the implementation of the present method comprises neutral atoms suitable for being manipulated to form the qubits. The manipulations are performed by light beams, such as lasers.

A neutral atom is an electrically neutral atom. Such neutral atoms are e.g. excited to Rydberg levels during the use of the quantum processor. The neutral atoms are e.g. rubidium atoms.

A quantum processor has an interaction Hamiltonian H describing the behavior of qubits, in particular the interactions thereof. In the case of a quantum processor with neutral atoms, the interaction Hamiltonian H is a function of the positions of the neutral atoms. For example, the interaction Hamiltonian corresponds to the Ising model. In such case, the interaction Hamiltonian H is e.g. given by the following formula:

$$H = {\sum }_{i \neq j} {U}_{i , j} = {\sum }_{i \neq j} \frac{{C}_{6}}{{\vert {r}_{j} - {r}_{i} \vert}^{6}}$$

### Where:

C₆ Is a coefficient dependent on the Rydberg level chosen as the excited state for the neutral atoms of the quantum processor,
rᵢ refers to the position of the qubit i, and
[symbol] refers to the occupancy operator of the qubit i, i.e. such that [symbol] x|nᵢ|x [symbol] =xᵢ.

Such a quantum processor with neutral atoms is e.g. such as same described in paragraph II of the article by Loïc Henriet, Lucas Beguin, Adrien Signoles, Thierry Lahaye, Antoine Browaeys, Georges-Olivier Reymond, and Christophe Jurczak. Quantum computing with neutral atoms. Quantum, 4:327, September 2020. ISSN 2521-327X. doi: 10.22331/q-2020-09-21-327.

Preferentially, at least certain steps of the method for determining the configuration of the quantum processor are implemented by another computer (classical or quantum), i.e. by a calculator interacting with a computer program product.

In such case, the calculator comprises e.g. a processor comprising a data processing unit, memories, a data storage medium reader and optionally a human-machine interface, such as a screen, and a display.

The computer program product comprises a data storage medium. The data storage medium is a medium readable by the calculator, usually by the data processing unit. The readable storage medium is a medium suitable for storing electronic instructions and apt to be coupled to a bus of a computer system. The computer program containing program instructions is stored on the data storage medium.

The computer program can be loaded into the data processing unit and is suitable for leading to the implementation of certain steps of a method for determining the configuration of the quantum processor when the computer program is implemented on the processing unit of the calculator.

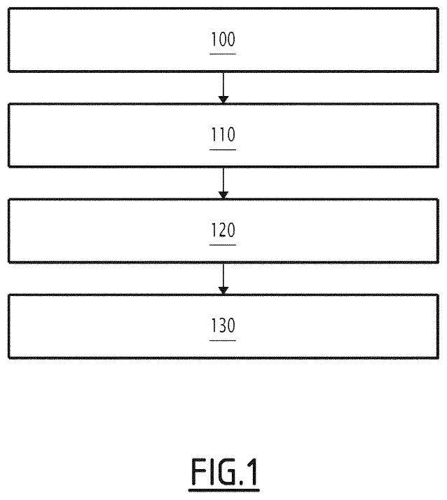

An example of a method for determining a configuration of a quantum processor for solving an optimization problem will now be described with reference to the flowchart shown in FIG. 1 and FIGS. 2 to 6 illustrating certain steps of the method.

The determination method comprises a step 100 of obtaining a matrix, called the QUBO M matrix, describing an optimization problem in the form of a quadratic unconstrained binary optimization. The optimization problem is e.g. a combinatorial optimization problem.

The obtaining step 100 is e.g. implemented by the calculator in interaction with the computer program product, i.e. is computer-implemented. The matrix QUBO is e.g. communicated to the calculator by an operator.

As explained hereinabove, a QUBO problem consists in finding the string of bits x∈ [symbol] , i.e. a vector with N dimensions of 0 and 1, minimizing the cost function C(x)=x^{T}Mx, with M the QUBO matrix. The QUBO M matrix is a symmetric real matrix.

The QUBO M matrix is specific to the optimization problem under consideration.

The determination method comprises a step 110 of determining a target Hamiltonian H_{c} for the quantum processor as a function of the QUBO matrix M. Hence the target Hamiltonian H_{c} is also specific to the optimization problem in question.

The determination step 110 is e.g. implemented by the calculator in interaction with the computer program product, i.e. is computer-implemented.

The target Hamiltonian H_{c} for the quantum processor is such that [symbol] x|H_{c}|x [symbol] =C(x), i.e. such that [symbol] x|H_{c}|x [symbol] =x^{T}Mx.

Using the previous notations for the occupation operator, the target Hamiltonian H_{c} is also expressed in the following form:

$${H}_{c} = {\sum }_{i , j} {M}_{i , j}$$

Insofar as the interaction Hamiltonian H of the quantum processor is expressed in the following form

$$H = {\sum }_{i \neq j} {U}_{i , j} = {\sum }_{i \neq j} \frac{{C}_{6}}{{\vert {r}_{j} - {r}_{i} \vert}^{6}} ,$$

one seeks to find the positions {rⱼ} of the neutral atoms, such that the interaction Hamiltonian H best approximates the target Hamiltonian H_{c}. In other words, U_{i,j} should be as close as possible to M_{i,j} for any i≠j.

The determination method comprises a step 120 of determining the positions of the neutral atoms of the quantum processor so as to minimize a difference between the interaction Hamiltonian H of the quantum processor and the target Hamiltonian H_{c}. In particular, the minimization of the difference corresponds to U_{i,j} the closest to M_{i,j}. The positions of the atoms are determined in a two-dimensional space (in a plane) or a three-dimensional space.

The determination step 120 is e.g. implemented by the calculator in interaction with a computer program product, i.e. is computer-implemented.

The determined positions define a configuration of the quantum processor suitable for being used in solving the optimization problem.

The step of determining the positions comprises the use of a machine learning tool suitable for determining the positions of the atoms as a function of data resulting from the target Hamiltonian H_{c}.

The learning tool is preferentially a manifold machine learning tool suitable for performing a non-linear reduction of the dimensionality of the data at the input of the tool. Such a tool implements an algorithm based on unsupervised estimators to describe data sets as small-dimensional collectors embedded into high-dimensional spaces.

Preferentially, the learning tool is based on a multidimensional scaling algorithm. Such an algorithm serves to change from a proximity matrix (similarity or dissimilarity) between a series of N objects, to the coordinates of the same objects in a P-dimensional space. When P is set to 2 or 3, it is easy to view the objects.

In a variant, the learning tool is based on another algorithm, e.g. an algorithm chosen from the following list: Isomap, Locally Linear Embedding, Modified Locally Linear Embedding, Hessian Eigenmapping, Spectral Embedding, Local Tangent Space Alignment, T-distributed Stochastic Neighbor Embedding.

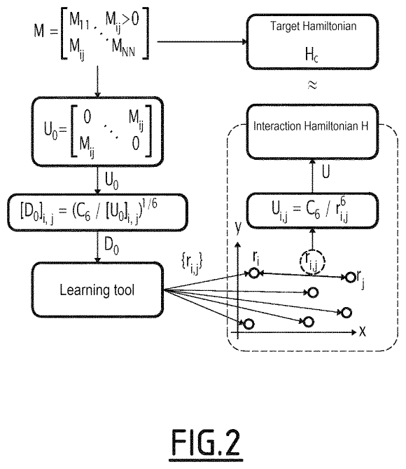

An example of the implementation of step 120 for determining positions is illustrated in FIG. 2 (left-hand column). In said example, the QUBO M matrix has positive coefficients outside the diagonal thereof. Preferentially, the QUBO M matrix is formulated as a symmetric real matrix with positive terms. Nevertheless, said example is generalized to any symmetrical QUBO M matrix.

In such example of implementation, the determination step 120 comprises the determination of an intermediate matrix U₀ as a function of the QUBO matrix M (symmetrical real matrix).

The intermediate matrix U₀ has coefficients equal to zero on the diagonal thereof and the same coefficients as the matrix QUBO M otherwise. The intermediate matrix U₀ is thus expressed in the following form:

$${U}_{0} = ( \begin{matrix}0 & … & {M}_{i , j} \\ ⋮ & ⋱ & ⋮ \\ {M}_{i , j} & … & 0\end{matrix} )$$

### Where:

$$M = ( \begin{matrix}{M}_{1 , 1} & … & {M}_{i , j} \\ ⋮ & ⋱ & ⋮ \\ {M}_{i , j} & … & {M}_{N , N}\end{matrix} )$$

is the QUBO matrix.

In said example, the determination step 120 comprises the determination of a matrix, called the distance matrix D₀, as a function of the intermediate matrix U₀. For example, the coefficients [D₀]_{i,j} of the distance matrix D₀ are obtained according to the following formula:

$${[ {D}_{0} ]}_{i , j} = \frac{{C}_{6}}{{( {[ {U}_{0} ]}_{i , j} )}^{1 / 6}}$$

Where:
[D₀]_{i,j} is the coefficient in row i and column j of the distance matrix D₀,
[U₀]_{i,j} is the coefficient in row i and column j of the intermediate matrix U₀, and
C₆ Is a coefficient dependent on the Rydberg level chosen as the excited state for the neutral atoms of the quantum processor.

Thereby, each coefficient [D₀]_{i,j} in the position i, j of the distance matrix D₀ corresponds to a distance between the qubit i and the qubit j.

In said example, the determination step 120 comprises the determination, by the learning tool, of the positions of the neutral atoms in space as a function of the distance matrix D₀. More precisely, the learning tool returns at output, the coordinates of each atom in the considered space.

Preferentially, the learning tool comprises parameters relating to the dimensions of the space, and to the number of iterations to be performed by the learning tool to obtain the final positions of the neutral atoms. Thereby, the determined positions of the atoms are the positions obtained at the end of the last iteration. In the present case, the space is two-dimensional or three-dimensional.

Once the positions have been determined, the corresponding interaction Hamiltonian H is obtained with the formula described hereinabove:

$$H = {\sum }_{i \neq j} {U}_{i , j} = {\sum }_{i \neq j} \frac{{C}_{6}}{{\vert {r}_{j} - {r}_{i} \vert}^{6}} .$$

In particular, each term U_{i,j} is determined one by one from r_{i,j}=|rᵢ−rⱼ|.

At the end of the method, U is a priori as close as possible to U₀, and the difference between the interaction Hamiltonian H and the target Hamiltonian H_{c} is minimal.

Optionally, the determination method comprises a step 130 of effectively positioning the neutral atoms of the quantum processor according to the positions determined for solving the optimization problem.

The positioning step 130 is implemented on the quantum processor in question, e.g. using tools for manipulating the neutral atoms. The tools are e.g. optical tweezers. In FIG. 2, in particular, the elements in the dotted-line box (right-hand column) correspond to an implementation on the quantum processor considered. The quantum processor is then used to solve the QUBO problem. The solving method uses e.g. a quantum adiabatic algorithm or a quantum approximate optimization algorithm.

Thereby, the present method serves to determine a configuration of a quantum processor with neutral atoms for solving an optimization problem expressed in a QUBO form. The use of the learning tool makes it possible to determine the positions of the neutral atoms of the quantum processor such that the difference between the interaction Hamiltonian H of the quantum processor and the target Hamiltonian H_{c} is minimal. The determined positions serve in particular to ensure that the states of the atoms useful for solving the QUBO problem, are possible states.

As a result, the performance of such a quantum processor is improved during the solving of the QUBO problem when the quantum processor is operating in analogue mode.

Hereinafter, we give examples of experiments carried out to demonstrate the improvement of the performance of a quantum processor induced by the present method during the solving of a QUBO problem.

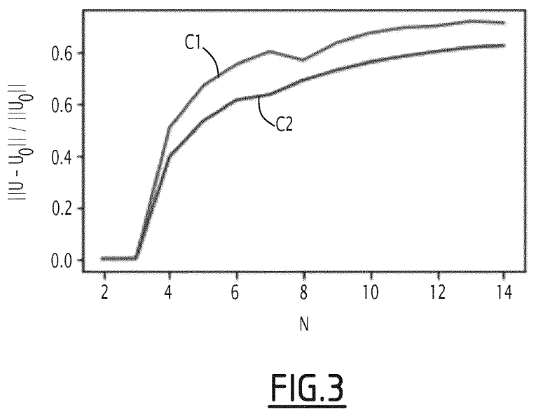

More particularly, FIGS. 3 to 5 aim, for a given QUBO M matrix, to compare the interaction part U₀ of the target Hamiltonian H_{c} with the interaction part U of the interaction Hamiltonian H for neutral atoms arranged in two different configurations, namely a positioning determined by the present method (curve C1 in the figures), and a so-called triangular positioning, where the atoms are placed on a triangular lattice (curve C2 in the figures).

For sizes N∈{2, . . . , 14}, 20 instances of each matrix family are approximated with the two aforementioned positioning configurations. The evolution of

$$‖ \frac{U - {U}_{0}}{{U}_{0}} ‖$$

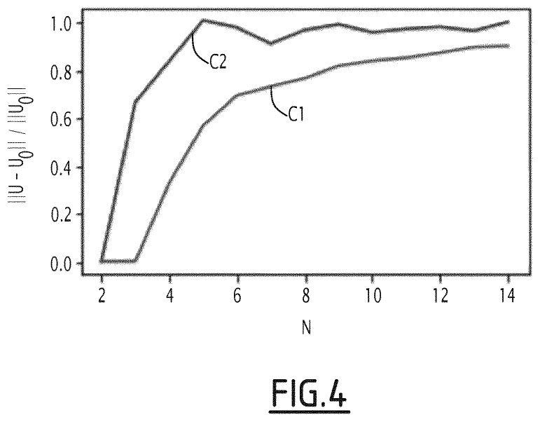

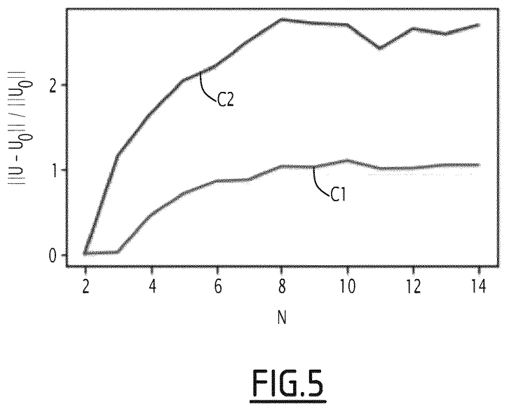

as a function of N is followed for the triangular configuration (curve C2) and the determined configuration (curve C1). The approximate matrices are generated as follows:
FIG. 3: M_{i,j}=m where m˜ [symbol] (0,1). All elements are identical.
FIG. 4:

$${M}_{i , j} = \frac{{m}_{i , j} + {m}_{j , i}}{2}$$

where m_{i,j}˜ [symbol] (0,1). The discrepancies between the elements are small.
FIG. 5:

$${M}_{i , j} = 1 {0}^{a , \frac{{m}_{i , j} + {m}_{j , i}}{2} - b}$$

where a=6, b=3 and m_{i,j}˜ [symbol] (0,1). a and b are taken so as to produce values comprised between 10⁻³ and 10³, the latter being approximately the strongest interaction that can take place at the Rydberg level chosen for the study. The discrepancies between the elements are thus larger.

For the triangular positioning, N atoms are arranged in a triangular array with an array spacing around the minimum value of D₀. The positioning determined by the method was obtained via the machine learning tool after 100 iterations.

In order to compare the relative performance of the two types of positioning,

$$‖ \frac{U - {U}_{0}}{{U}_{0}} ‖$$

(with ∥ ∥ the Frobenius standard) is calculated for both configurations. The results are presented in FIGS. 3 to 5 for the different families of matrices M.

In FIG. 3, the matrices the elements of which are all equal, are considered. Such matrices are well represented by the triangular configuration because the latter maximizes the number of pairs of atoms that can be considered as the closest neighbors and hence the number of distances equal to the spacing. In such case, the positioning determined by the method does not produce better solutions when the method is limited to a fixed number of iterations.

In FIG. 4, matrices are considered the elements of which follow a uniform distribution between 0 and 1. The positioning determined by the method is better than the triangular positioning for a small number of atoms but the difference tends to decrease when N increases.

In FIG. 5, the matrices have larger differences between the elements thereof, i.e. such as

$$\frac{max M}{min M} ≫ 1.$$

The matrices are closely related to the dependent matrices

$$\frac{1}{r 6}$$

usually present in the Rydberg Hamiltonian, and hence a positioning approaching M is easier to achieve by the present method. In such case, the configuration determined by the present method clearly surpasses the triangular positioning.

Thereby, from the examples, it is clear that the present method makes it possible to provide positioning configurations for neutral atoms leading to a Hamiltonian approximation that is more relevant, and hence more efficient, than the triangular positioning, in the case where the elements of the QUBO matrix differ by several orders of magnitude.

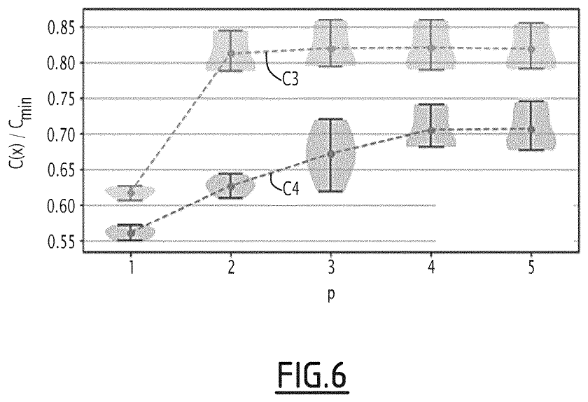

FIG. 6 illustrates a comparative example of the performance of a quantum processor for solving a QUBO problem using a QAOA algorithm when the neutral atoms of the processor are positioned according to a position determined by the method of the invention, and during a triangular position.

The complexity of the QAOA algorithm is given by the number of p-layers applied. By increasing p, the optimization efficiency should increase as well. 5 QUBO of size 10 to optimize, are considered herein. A QAOA algorithm is applied to each of QUBOs with an increasing number of layers and the two different positioning configurations. In the first case, a triangular positioning is applied for atoms for the 5 QUBOs, with the exception of the rescaling factor. In the second case, the present method is applied to each of the QUBOs and the positioning of the atoms used is then specific to the QUBO to be solved. The normalized cost function C(x)/Cmin (C(x) being negative and

$${C}_{min} = {min}_{x ∈ {𝔹}^{N}} C ( x ) )$$

should tend toward 1 when minimizing the QUBO.

FIG. 6 illustrates the distributions of the scores achieved for the 5 QUBOs with increasing values of number of layers. In FIG. 6, the triangular configuration corresponds to the curve C4, and the specific configuration determined by the present method corresponds to the curve C3. For both configurations, the mean score increases with p as expected, but at a given p, the QAOA achieves better scores using the configuration determined by the present method. For example, for p=5, the average score for the 5 QUBO is about 0.71 for the triangular positioning but rises to 0.82 for the specific positioning. The present method thereby improves the performance of the quantum processor when solving a QUBO problem.

A person skilled in the art will understand that the embodiments and variants described above can be combined so as to form new embodiments provided that same are technically compatible.

1. A method for determining a configuration of a quantum processor for solving an optimization problem, the quantum processor comprising neutral atoms suitable for being manipulated to form qubits, the quantum processor having an interaction Hamiltonian describing the interactions between qubits, the interaction Hamiltonian being function of the positioning of the neutral atoms, the method comprising, implemented by a calculator, the following steps:
a. determining a target Hamiltonian for the quantum processor according to a QUBO matrix, the QUBO matrix describing the optimization problem in the form of a quadratic unconstrained binary optimization, and
b. determining the positions of the neutral atoms of the quantum processor so as to minimize a difference between the interaction Hamiltonian of the quantum processor and the target Hamiltonian, the step of determining the positions comprising the use of a machine learning tool that is able to determine the positions of the atoms according to data from the target Hamiltonian, the determined positions defining a processor configuration suitable for being used for solving the optimization problem.

2. The method of solving an optimization problem by a quantum processor, said method of solving comprising the steps of the method of determining a configuration of the quantum processor according to claim 1, and wherein the method of solving comprises a step of positioning the neutral atoms of the quantum processor according to the positioning determined for solving the optimization problem.

3. The method according to claim 2, wherein the method comprises a step of solving the optimization problem, with the neutral atoms of the quantum processor positioned according to the determined positioning, by using a quantum approximate optimization algorithm, called QAOA, or a quantum adiabatic algorithm.

4. The method according to claim 1, wherein the learning tool is a manifold machine learning tool suitable for performing a non-linear reduction of the dimensionality of the data at the input of the tool.

5. The method according to claim 4, wherein the multiple machine learning tool is based on a multi-dimensional positioning algorithm.

6. The method according to claim 1, wherein the QUBO matrix is formulated in the form of a symmetric real matrix, the step of determining the positions comprising:
a. the determination of a matrix, called the distance matrix, as a function of the QUBO matrix, each coefficient in a position i, j of the distance matrix corresponding to a distance between the qubit i and the qubit j, and
b. the determination, by the learning tool, of the positions of the neutral atoms according to the distance matrix.

7. The method according to claim 6, wherein the step of determining the positions comprises the determination of an intermediate matrix as a function of the QUBO matrix, the intermediate matrix having coefficients equal to zero on the diagonal thereof and the same coefficients as the QUBO matrix otherwise, the distance matrix being obtained as a function of the intermediate matrix.

8. The method according to claim 7, wherein the coefficients of the distance matrix are obtained according to the following formula:
$${[ {D}_{0} ]}_{i , j} = \frac{{C}_{6}}{{( {[ {U}_{0} ]}_{i , j} )}^{1 / 6}}$$
Where:
[D₀]_{i,j} is the coefficient in row i and column j of the distance matrix D₀,
[U₀]_{i,j} is the coefficient in row i and column j of the intermediate matrix U₀, and
C₆ Is a coefficient dependent on a Rydberg level chosen as the excited state for the neutral atoms of the quantum processor.

9. The method according to claim 1, wherein the target Hamiltonian satisfies the following equation:
$$〈 x \vert {H}_{c} \vert x 〉 = {x}^{T} Mx$$
Where:
H_{c} is the target Hamiltonian for the optimization problem under consideration,
M is the QUBO matrix,
x is a state vector,
x^{T} is the transpose of the vector x, [symbol]
Φ| is the bra of Φ in bra-ket notation, and

|Ψ [symbol] is the ket of Ψ in bra-ket notation.

10. (canceled)

11. A readable storage medium on which is stored a computer program comprising program instructions, the computer program being loaded on a data processing unit and leading to the implementation of steps of determination of a target Hamiltonian and of determination of the positions of the method according to claim 1 when the computer program is implemented on the data processing unit.
